(19) United States
(12) Patent Application Publication
(10) Pub. No.: US 2026/0295810 A1
(43) Pub. Date: Oct. 1, 2026

(54) ROBOT PROGRAMMING WITH ACTIVE ASSISTING FUNCTIONS

(71) Applicant: Universal Robots A/S, Odense S (DK)

(72) Inventors: Rune Søe-Knudsen, Odense S (DK); Jens-Jakob Bentsen, Odense S (DK); Nicolai Anton Lynnerup, Odense S (DK)

(73) Assignee: Universal Robots A/S, Odense S (DK)

(21) Appl. No.: 19/480,765

(22) PCT Filed: May 1, 2024
(86) PCT No.: PCT/DK2024/050102

§ 371 Date: Oct. 31, 2025

(30) Foreign Application Priority Data
May 2, 2023 (DK) PA20230009

(51) Int. Cl. B25J 9/00; B25J 9/16; G05B 19/42

(52) U.S. Cl. CPC B25J 9/0081; B25J 9/1656; G05B 19/42; B25J 9/0093

(57) ABSTRACT

A robot system comprises at least one robotic arm controlled by a robot controller comprising: a recording process which can be activated by a user via the user interface device and the robot controller is during the recording process configured to record at least one operation parameter of the robot system; an assisting process which during the recording process is configured to execute at least one assisting function upon activation by the user, where the at least one assisting function activates at least one robot system action. robot task generator configured to generate at least one robot task based on the at least one executed assisting function and at least one of the recorded operation parameters.

### FIELD OF THE INVENTION

The present invention relates to a robot controller and a method for programming a robot system comprising a robotic arm by utilizing programming by demonstration (PbD).

### BACKGROUND OF THE INVENTION

Robot systems comprising robotic arms are widely used to perform automated tasks where the robotic arm handles objects, manipulates objects and/or inspects objects. Examples of known types of tasks that such robot systems can perform are for instance palletizing/de-palletizing tasks, assembly tasks, dispensing tasks, finishing tasks, machine tending tasks, material handling tasks, material removal tasks, quality inspection tasks, welding tasks etc.

Robotic arms comprising a plurality of robot joints and links where motors or actuators can move parts of the robotic arm in relation to each other are known in the field of robotics. Typically, the robotic arm comprises a robot base which serves as a mounting base for the robotic arm; and a robot tool flange where to various tools can be attached. A robot controller is configured to control the robot joints in order to move the robot tool flange in relation to the base. For instance, in order to instruct the robotic arm to carry out a number of working instructions. The robot joints may be rotational robot joints configured to rotate parts of the robotic arm in relation to each other, prismatic joints configured to translate parts of the robotic arm in relation to each other and/or any other kind of robot joints configured to move parts of the robotic arm in relation to each other.

Typically, the robot controller is configured to control the robot joints based on a dynamic model of the robotic arm, where the dynamic model defines a relationship between the forces acting on the robotic arm and the resulting accelerations of the robotic arm. Often, the dynamic model comprises a kinematic model of the robotic arm, knowledge about inertia of the robotic arm and other parameters influencing the movements of the robotic arm. The kinematic model defines a relationship between the different parts of the robotic arm and may comprise information of the robotic arm such as, length, size of the joints and links and can for instance be described by Denavit-Hartenberg parameters or like. The dynamic model makes it possible for the controller to determine which torques and/or forces the joint motors or actuators shall provide to move the robot joints for instance at specified velocity and/or specified acceleration or to hold the robotic arm in a static posture.

End effectors, such as grippers, vacuum grippers, magnetic grippers, screwing machines, welding equipment, dispensing systems, visual systems etc., may also be attached to the tool flange or other places of the robotic arm and thereby form part of the robot system.

In addition to the robotic arm and end effector the robot system often also comprises a number of devices such as process equipment like conveyers, pallets, CNC machines, sorting machines, fixtures for arranging objects like workpieces, various safety equipment, visual systems etc.

A robot system needs to be programmed by a user, such as a robot integrator who defines various instructions for the robot system, the robotic arm, the end effector, and other devices of the robot system. This is a complicated task as it requires significant knowledge of the components of the robot system, and the process that the robot system needs to perform.

Programming by Demonstration (PbD), Programming by Example (PbE), Learning from Demonstrations (LfD), Imitation Learning, Kinesthetic teaching/learning or teaching by showing are terms relating to a programming paradigm, where a user can create a program without needing to learn the details of a programming language, but instead demonstrate the action(s) which the system should perform. The terms above may throughout this application all be used to refer to this program paradigm.

Various aspects of Programming by Demonstration have for instance been disclosed in the following publications:
{i.} Halbert, Daniel Conrad. PHD thesis “Programming by Example”, Department of Electrical Engineering and Computer Sciences, University of California, Berkeley, November 1984, https://danhalbert.org/pbe.pdf
{ii.} Billard, Aude, et al. “Robot programming by demonstration.” Springer handbook of robotics. Springer, Berlin, Heidelberg, 2008. 1371-1394
{iii.} Argall, Brenna D., et al. “A survey of robot learning from demonstration.” Robotics and autonomous systems 57.5 (2009): 469-483
{iv.} Ravichandar, Harish, et al. “Recent advances in robot learning from demonstration.” Annual review of control, robotics, and autonomous systems 3 (2020): 297-330. [5] Argall, Brenna D., Brett Browning, and Manuela
{v.} Dey, Anind K., et al. “a CAPpella: programming by demonstration of context-aware applications.” Proceedings of the SIGCHI conference on Human factors in computing systems. 2004

WO 2017/17178469 discloses a method and computer program product for programming a robot by manually operating it in gravity-compensation kinesthetic-guidance mode. More specifically there is provided method and computer program product that uses kinesthetic teaching as a demonstration input modality and does not require the installation or use of any external sensing or data-capturing modules. It requires a single user demonstration to extract a representation of the program and presents the user with a series of easily controllable parameters that allow them to modify or constrain the parameters of the extracted program representation of the task.

EP 2 905 111 A2 discloses a method for programming an industrial robot includes moving a manipulator arm of the industrial robot manually (hand guided) into at least one pose in which at least one control variable, which is to be entered in a robot program, is recorded by a control device of the industrial robot and is saved as a parameter of an associated program instruction in the robot program. In another aspect, an industrial robot includes a robot control unit which is designed and/or configured to carry out such a method.

US 2019/0168390 A1 discloses a method that includes receiving position data indicative of position of a demonstration tool. Based on the received position data, the method further includes determining a motion path of the demonstration tool, wherein the motion path comprises a sequence of positions of the demonstration tool. The method additionally includes determining a replication control path for a robotic device, where the replication control path includes one or more robot movements that cause the robotic device to move a robot tool through a motion path that corresponds to the motion path of the demonstration tool. The method also includes providing for display of a visual simulation of the one or more robot movements within the replication control path.

Despite that robot systems utilizing Programming by Demonstration have been desired for a long time, the technologies developed have not been adopted widely in the industry of robot systems.

### SUMMARY OF THE INVENTION

The objective of the present invention is to address the above-described limitations with the prior art or other problems of the prior art. This is achieved by a robot system and method for programing the robot system according to the independent claims.

The robot system comprises at least one robotic arm controlled by a robot controller according to a robot program, where the robot program specifies a number of robot tasks and an order of execution of the robot tasks, where the robot system comprises a user interface device enabling a user to communicate with the robot system, the robot controller is configured for performing:
a recording process which can be activated by a user via the user interface device and the robot controller is during the recording process configured to record at least one operation parameter of the robot system;
an assisting process which during the recording process is configured to execute at least one assisting function upon activation by the user, where the at least one assisting function activates at least one robot system action;
   wherein the robot controller comprises robot task generator configured to generate at least one robot task (T3) based on the at least one executed assisting function and at least one of the recorded operation parameters.

The method of programming the robot system comprises the steps of:
activating a recording process of the robot system, where the robot controller during the recording process records at least one operation parameter of the robot system;
during the recording process activating at least one assisting function of the robot system, were the at least one assisting functions activates at least one predefined robot system action;
generating at least one robot task to the robot program based on the selected at least one assisting function and at least one of the recorded operation parameters.

The robot system and method according to the present invention makes it possible for a user programming the robot system to demonstrate robot tasks, that the robot system shall execute when operating, in a simple and intuitive way. This is achieved by the user activating the recording process, whereby the robot controller is informed that the user is about to demonstrate a robot task that is to be inserted into the robot program, and thus initiates the recording process where operational parameters of the robot system is recorded.

The known PbD concepts heavily relies on near perfect demonstrations from the user and/or attempts to automatically estimate the user's intentions from the data obtained during the recording. In contrast hereto the robot system and method according to the present invention provides a new way of segmenting a demonstration based on the user's intentions. This is achieved as the user's intentions during the recording process are provided to the robot system through the user's activation of assisting functions. For instance, the assisting functions can assist the user in obtaining the sub-mm (millimeter) precision needed for a successful demonstration and consequently robot program. These assisting functions can provide primitive behaviors or advanced skills in the form of robot system actions.

The dependent claims describe possible embodiments of the method according to the present invention. Further advantages and benefits of the present invention are described in the detailed description of the invention.

### BRIEF DESCRIPTION OF THE DRAWINGS

FIG. 1 illustrates a prior art robot system comprising a robotic arm;

FIG. 2 illustrates a robotic system according to the present invention;

FIG. 3 illustrates a method for programming a robot system according to the present invention;

FIG. 4 illustrates an embodiment of a method of programming a robot system according to the present invention;

FIG. 5 illustrates an embodiment of a robot controller according to the present invention;

FIG. 6 illustrates a sequential diagram of a method of programming the robot system according to the present invention;

FIG. 7 illustrates a method of demonstrating a grid pattern.

### DETAILED DESCRIPTION OF THE INVENTION

The present invention is described in view of exemplary embodiments only intended to illustrate the principles of the present invention. The skilled person will be able to provide several embodiments within the scope of the claims. Throughout the description, the reference numbers of similar elements providing similar effects have been given the same last two digits. Further it is to be understood that in the case that an embodiment comprises a plurality of the same features then only some of the features may be labeled by a reference number.

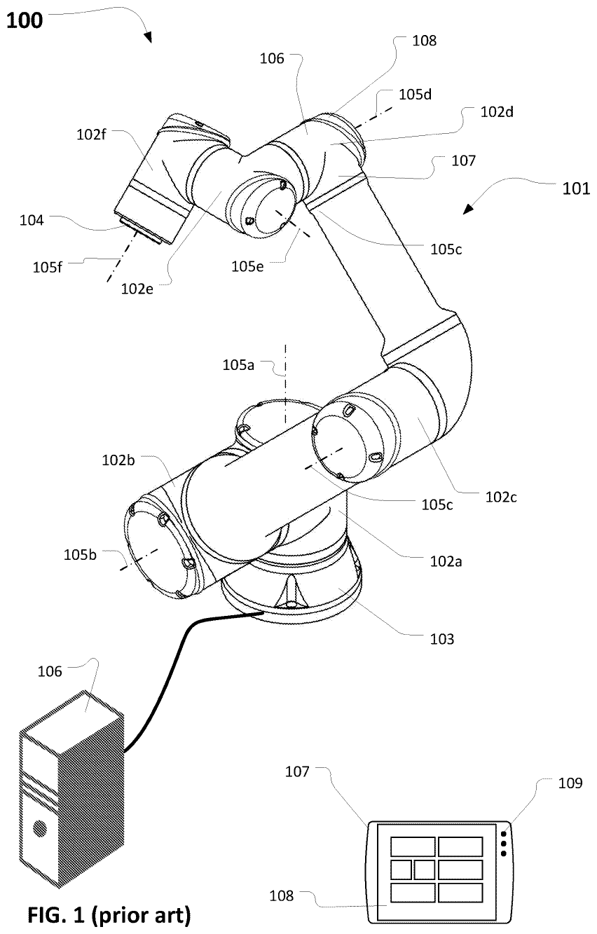

FIG. 1 illustrates a robot system 100 as known in the prior art. The robot system comprises at least one robotic arm 101 and at least one robot controller 106 configured to control the robotic arm. The robotic arm 101 comprises a plurality of robot joints 102a, 102b, 102c, 102d, 102e, 102f connecting a robot base 103 and a robot tool flange 104. A base joint 102a is configured to rotate the robotic arm around a base axis 105a (illustrated by a dashed dotted line); a shoulder joint 102b is configured to rotate the robotic arm around a shoulder axis 105b (illustrated by a dashed dotted line); an elbow joint 102c is configured to rotate the robotic arm around an elbow axis 105c (illustrated by a dashed dotted line); a first wrist joint 102d is configured to rotate the robotic arm around a first wrist axis 105d (illustrated by a dashed dotted line) and a second wrist joint 102e is configured to rotate the robotic arm around a second wrist axis 105e (illustrated by a dashed dotted line). Robot joint 102f is a robot tool joint comprising the robot tool flange 104, which is rotatable around a tool axis 105f (illustrated by a dashed dotted line). The illustrated robotic arm is thus a six-axis robotic arm with six degrees of freedom with six rotational robot joints, however it is noticed that the present invention can be utilized in robotic arms comprising less or more robot joints and that some of the robot joints may be provided as prismatic robot joint translating two or more robot parts in relation to each other.

The robot joints comprise a robot joint housing and an output flange rotatable or translatable in relation to the robot joint housing and the output flange is connected to a neighbor robot joint either directly or via an arm section as known in the art. The robot joint comprises a joint motor configured to rotate or translate the output flange in relation to the robot joint housing, for instance via a gearing or directly connected to the motor shaft. The robot joint housing can for instance be formed as a joint housing and the joint motor can be arranged inside the joint housing and the output flange can extend out of the joint housing. Additionally, the robot joints can comprise at least one joint sensor providing a sensor signal for instance indicative of at least one of the following parameters: an angular and/or linear position of the output flange, an angular and/or linear position of the motor shaft of the joint motor, a motor current of the joint motor or an external force and/or torque trying to rotate the output flange or motor shaft. For instance, the angular position of the output flange can be indicated by an output encoder such as optical encoders, magnetic encoders which can indicate the angular position of the output flange in relation to the robot joint. Similarly, the angular position of the joint motor shaft can be provided by an input encoder such as optical encoders, magnetic encoders which can indicate the angular position of the motor shaft in relation to the robot joint. It is noted that both output encoders indicating the angular position of the output flange and input encoders indicating the angular position of the motor shaft can be provided, which in embodiments where a gearing have been provided makes it possible to determine a relationship between the input and output side of the gearing.

The robot system may also comprise an end effector (not illustrated) attached to the robot tool flange, and it is to be understood that the end effector can be any kind of end effectors such as grippers, vacuum grippers, magnetic grippers, screwing machines, welding equipment, gluing equipment, dispensing systems, painting equipment, visual systems, cameras etc.

The robot system comprises at least one robot controller 106 configured to control the robotic arm 101. The robot controller is configured to control the motions of the parts of the robotic arm and the robot joints for instance by controlling the motor torque provided to the joint motors based on a dynamic model of the robotic arm, the direction of gravity acting and the joint sensor signals. The controller can be provided as an external device as illustrated in FIG. 1 or as a device integrated into the robotic arm or as a combination thereof.

The robot system can be controlled by a robot controller according to a robot program, where the robot program specifies a number of robot tasks and an order of execution of the robot tasks where the robot tasks define a number of actions that the robot system shall perform. The robot controller can comprise an interface device 107 enabling a user to control and program the robot system. The interface device can for instance be provided as a teach pendant as known from the field of industrial robots which can communicate with the controller via wired or wireless communication protocols. The interface device can for instanced comprise a display 108 and a number of input devices 109 such as buttons, sliders, touchpads, joysticks, track balls, gesture recognition devices, keyboards, microphones etc. The display may be provided as a touch screen acting both as display and input device. The interface device can also be provided as an external device configured to communicate with the robot controller, for instance in form of smart phones, tablets, PCs, laptops etc.

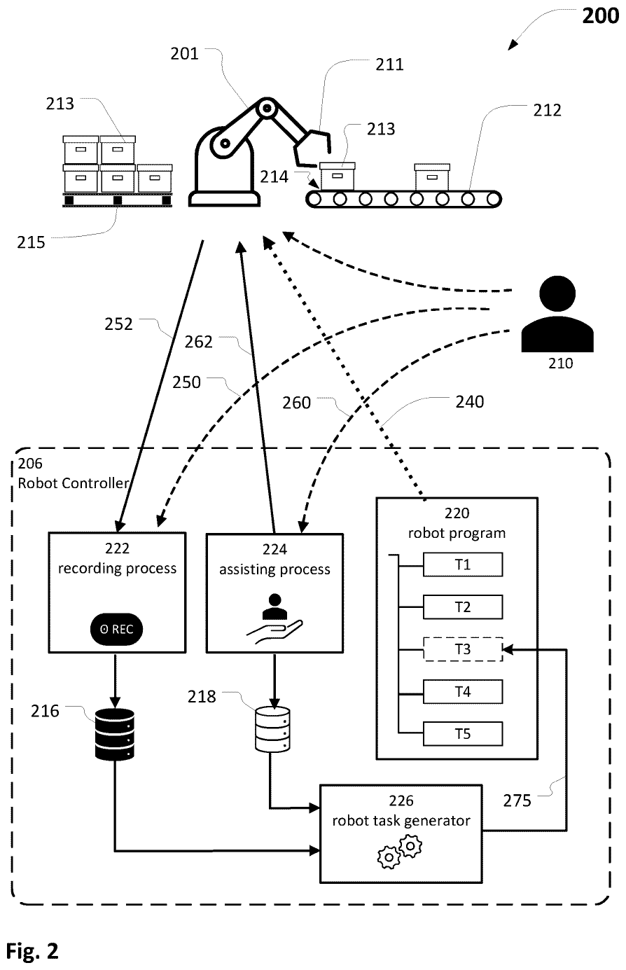

FIG. 2 illustrates a robot system 200 according to the present invention. The robot system 200 comprises at least one robotic arm 201 controlled by a robot controller 206 and a user interface device (not shown) enabling a user 210 to communicate with the robot system.

The robot system 200 is illustrated as a palletizing system comprising a robotic arm 201 with a gripper 211, a conveyer belt 212 feeding a number of boxes 213 to a pickup location, where after the robotic arm picks up the boxes and stacks the boxes onto a pallet 215. However, it is to be understood that the illustrated palletizing system only is intended to illustrate one kind of robot system comprising a robotic arm and a number of devices (in this example the conveyor, boxes and pallet), and the skilled person will be able to provide a large variety of robots systems used for carrying out a large variety of automated applications utilizing a robotic arm.

The robotic arm 201 can be any kind of robotic arm known in the field of robotic arms comprising robot joints, a base, and at least one tool flange where the robot joints connect the base and the tool flange. The illustrated robotic arm is in form of a six-axis robotic arm, where the base and tool flange are connected by six consecutive robot joints where robot links are provided between some of the robot joints. However, it is to be understood that the robotic arm can comprise any number of robot joints and/or robot links, for instance two or more robot joints, three robot joints, four robot joints, five robot joints, seven robot joints, eight robot joints etc. Further, the robotic arm can be provided as a scara robot, a delta robot or parallel robots.

The gripper 211 can be any known gripping device suitable for picking up objects. The robotic arm can for instance be like the robotic arm 101 illustrated and described in connection with FIG. 1.

The robot controller 206 comprises a robot program 220, a recording process 222, an assisting process 224 and a robot task generator 226. The robot controller 206 is configured to control the robot system according to the robot program 220 as illustrated by dotted arrow 240 by instructing the robot system to execute a number of robot tasks (T1-T5) as known in the art of robotics. Typically, the robot controller controls the robot system according to the robot program when the robot system is in operation/run mode and the robot controller may comprise an operation process (not shown) which is running in operation mode of the robot system and controls the robot system according to the robot program. It is to be understood that the robot controller can control both the robotic arm 201 and potential other devices of the robot system, such as the end effectors and other devices described in connection with FIG. 1.

The robot program specifies a number of robot tasks (T1-T5) and an order of execution of the robot tasks. A robot task can be any action that the robot system or a part of the robot system performs, and a robot task can define one or a plurality of actions that the robot system shall perform. A robot task may thus define a number of actions to be performed by the robotic arm, end effectors or other devices of the robot system. The robot program also defines the order of which the robot tasks shall be executed for the robot system to carry out the automated task. In one embodiment the order of execution may for instance be a sequential execution of the robot tasks in a predefined order, however the order of execution may also be defined by utilizing well known program logic where the order of execution of the robot tasks depends on various parameters and conditions of the robot system, additionally some of the robot tasks may also be executed simultaneously.

As a non-limiting example, the robot program 220 of the palletizing system of FIG. 2 comprises robot tasks T1-T5 where:

T1: Starts conveyer 212, whereby the boxes 213 are conveyed towards the pickup location 214 near the robotic arm. The skilled person will realize that boxes need to be positioned at the conveyor belt for instance by some other machinery or automated equipment, however for the sake of simplicity this part is omitted in this example.

T2: Stops conveyer belt 212 when a box 213 has arrived at the pickup location 214. The robot system may for instance comprise a sensor that can detect when a box has arrived at the pickup location and the sensor can then send a signal to the robot controller which then initiates robot task T2 of stopping the conveyer.

T3: Grasp the box with a gripper at the robotic arm. The gripping tasks can for instance comprises steps of:
opening the gripper 211;
moving the gripper into a gripping position, where the gripper can grasp the box;
closing the gripper;
change the payload setting reflecting the payload of objects carried by the robotic arm to reflect the payload of the box.

T4: Moving and placing the box onto the pallet 215, which may comprise steps of:
identifying a desired placement position on the pallet 215, this is typically based on knowledge of the sizes of the boxes, the pallet, a desired stacking pattern and number of boxes previously stacked at the pallet. For sake of simplicity this process is not described further;
moving the box to the desired placement position;
opening gripper;
moving the robotic arm to a waiting position near the pickup location;

T5: Waiting for the next box to arrive at the pickup location for the robotic arm to grasp using the gripper.

In the example above the robot tasks comprise a plurality of different steps that the robot system shall perform, however it is to be understood that the robot tasks may define a single or plurality of steps that need to be performed by the robot system. Additionally, a robot task may comprise a number of robot sub-tasks that the robot system shall perform.

The recording process 222 can be activated by a user 210 as illustrated by dashed arrow 250 via the user interface device and the robot controller is configured to record as illustrated by arrow 252 at least one operation parameter relating to the robot system while the recording process is activated. The recorded operational parameters can be stored in a recording memory storage 216 for further use by the robot controller. The operational parameter can be any parameters, values and/or states relating to the robot system such as sensor parameters obtained via various sensors of the robot system, such as position, speed, acceleration of the robot joints, values of force/torque sensors of the robot system, images/depth maps obtained by visual sensors, environmental sensor parameters such as temperature, humidity etc.; distances measured by distance sensors, position of devices external to the robotic arm such as conveyer positions, speed, acceleration. The operational parameter can also be status parameters of devices of the robotic system such as status of end effectors, status of devices external to the robotic arm, status of safety devices etc. and such parameters can be obtained via any kind of communication ports of the robot system e.g., digital in/output ports, ethernet or analog ports. Additionally, the operational parameter can be parameters generated by the robot program during the recording process such as target torque, positions, speed, acceleration of the robot joints, target force/torques that parts of the robotic arm or other parts of the robotic system shall generate, values of logic operators such as counters, logic values. The operational parameters can also be external information provided by external systems or central services or other systems for instance in form of information sent to and from central servers over a network.

The user 210 can, while the recording process is activated via the user interface, activate the assisting process 224 as illustrated by dashed arrow 260. The assisting process is during the recording process configured to execute at least one assisting function as illustrated by arrow 262.

An assisting function is a function which upon activation by the user during the recording process activates at least one robot system action, where the robot system action causes at least a part of the robot system to perform a predefined action. For instance, a robot system action may cause the robot system to:
Move the robotic arm to a predefined position;
Observing states of one or more predefined operational parameter(s) and/or change the state of one or more predefined operational parameter(s);
Wait for a signal state to change e.g., a sensor indicate that a box is ready on the pickup location 214; that a CNC machine is ready for delivery of new workpieces or have finished a workpiece that shall be picked up, etc.;
Cause an end effector to do something such as opening/closing a gripper, initiating/simulating welding by a welding torch, initiation/simulation gluing by a gluing dispenser, activating a screwing machine etc.;
Move the robotic arm according to one or more preferred moving patterns;
Align parts of the robot system or objects in the perimeter of the robot system;
Perform measurements utilizing sensors of the robotic system;
Cause a device external to the robotic arm to perform an action, such as activating/deactivating a conveyor belt, opening/closing doors of external machinery such as an CNC machine, etc.;

It is to be understood that the mentioned robot system actions only serve to illustrate some robot system action that can be activated by the user upon activating an assisting function.

In one embodiment the assisting process can be configured to store assisting parameters relating to the assisting function in an assisting parameter memory storage 218. In the illustrated embodiment the assisting parameter memory storage and the recording memory storage are illustrated as two different memory storages, however it is to be understood that they can be implemented on the same memory storage device and be integrated into a common data storage system. The assisting parameter can be any parameter generated in connection with the robot system action and can for instance be used to indicate certain events relating to the execution of the assisting function.

In one embodiment the assisting process is upon activation of an assisting function configured to execute an assisting robot program that causes the robot system to perform the predefined robot action. The assisting robot program executed by the assisting function can have the same structure as the robot program with a number of robot tasks and defined order of execution, and can be provided as robot code defining a number of instructions for the robot system. In one embodiment the assisting robot program executed by at assistant function can be provided in the same programming language of the robot program as this makes it easier for a user to provide assisting functions.

In one embodiment the assisting process is upon activation of an assisting function configured to instruct the recording process to record at least one operational parameter specified by the assisting function.

The robot task generator 226 is configured to generate at least one robot task T3 based on the assisting function executed by assisting process 224 and at least one of the operation parameters recorded by the recording process. In other words, the robot task generator is configured to generate robot program code which can be added/inserted as illustrated by arrow 275 into the robot program used to control the robot system. This is illustrated in FIG. 2 by robot task T3 (dashed lines) which is inserted into robot program between robot tasks T2 and T4.

The robot system, according to the present invention, makes it possible for a user programming the robot system to demonstrate robot tasks, that the robot system shall execute when operating, in a simple and intuitive way. This is achieved by the user activating the recording process, whereby the robot controller is informed that the user is about to demonstrate a robot task that is to be inserted into the robot program, and thus initiates the recording process where operational parameters of the robot system is recorded. The user can then during the recording program activate an assisting function which then can assist the user demonstrating the intended robot task by executing a robot action by the robot system. The robot task generator then generates and inserts a robot task into the robot program based on the recorded operational parameters and the activated assisting function(s). The robot task generator can recognize the selected assisting functions and the recorded operation parameters. Based on the recognized assisting functions and recorded operational parameters the robot task generator can decide how/which the robot task shall be generated and inserted into the robot system.

It is to be understood that not all of the robot tasks of the robot program need to be generated utilizing the robot system and method according to the present invention, as some of the robot tasks T1, T2, T4, T5 may be generated through traditional robot programming. In addition, robot task T3 generated by utilizing the robot system and method according to the present invention does not need to be defined and demonstrated in single linear flow and can be generated in multiple iterations. Further it is to be understood that a part of the robot tasks T3 generated by utilizing the robot system and method according to the present invention can be generated utilizing other kinds of programming methods, such as traditional robot programming. It is also to be understood that the robot task T3 generated by utilizing the robot system and method according to the present can form part of the robot program as a program task that can be called/executed by another robot program or robot task.

In one embodiment the assisting function is configured to provide instructions to the user relating to the robot task that need to be generated during a programming process. This makes it possible to guide the user to perform specific demonstrations that may be needed in order to generate a desired robot task.

In one embodiment the assisting function is associated with at least one assisting setting parameter and the assisting setting parameter indicates at least one parameter influencing the execution of the robot system action. The assistant setting parameter can be any parameter which can be used by the assisting function when executing the robot system action. For instance, the assistant setting parameter can define speed, timing, duration, direction, force, acceleration, positions relating to the assisting function, and it is to be understood that the user prior to or during the execution of the assisting function may define or redefine the assisting setting parameters of the assisting function in order to demonstrate the desired robot task.

In one embodiment the assisting function is configured to activate at least one additional assisting function, where the at least one additional assisting function activates at least one additional predefined robot system action. This makes it possible to provide more complex assisting functions which can be based on other assisting functions as the assisting function can call other assisting functions whereby assisting functions performing different robot system actions can be performed. This is also beneficial when developing new assisting functions as the new assisting functions can be based on previously provided assisting functions.

In one embodiment the assisting function is configured to imitate at least a part of the robot system action without actually performing the robot system action. This is useful in demonstration situation where actual execution of the robot system action that needs be demonstrated may constitute a risk for the user demonstration. For instance, if a user demonstrates a welding process by hand guiding a welding tool it may not be desired to actually activate the welding tool instead assisting function is configured to imitate the welding for instance by turning on light indicating welding, or a user demonstrating a drilling process the user may want to demonstrate drilling positions and also demonstrate the actual drilling but without actually performing the drilling.

The robot task generator may also be configured to generate to robot task based on the assisting setting parameters of the executed assisting functions.

In one embodiment the assisting function is associated with one or more properties defining one or more characteristics of the assisting function, such as function type, function requirements, relationship with other assisting functions, dependencies of other assisting functions or parts of the robotic system, inputs required to the assisting function and outputs provide by the assisting function, etc. Function type properties may provide an indication of the function of the assisting functions for instance in form of keywords, labels and/or a brief description of the function that the assisting function will carry out and/or what kind of program code can be generated by executing the assisting function. Function requirements properties may provide information of requirements that need to be fulfilled before the user can activate the assisting function. Some assisting function may need parts of the robot system to be in a certain state to be executed. For instance, an assisting function activating an end effector may require that the end effector is installed onto the robotic arm, and assisting function activating a peripheral device such as a conveyer may require that a connection between the robot controller and the conveyer has been established. Some assisting functions may also require that the safety settings of the robotic system fulfill certain requirements. Relationship and dependency parameters may define how the assisting functions relates to other assisting functions and/or parts of the robotic system. For instance, that another assisting function need to be performed before the assisting function can be executed or if another assisting function is required to be executed after the assisting function has been executed. Input properties may indicate inputs needed for the assisting function for instance input parameters that needs to be set in order to the assisting function to be executed. As an example, an assisting function moving parts of the robotic arm may need a direction defining the direction of movement. Output properties may provide a definition of the output that the assisting function generates for instance in form of an indication of one or more parameters that will be set based on the execution of the assisting function and/or exemplary program code generated based on the execution of the assisting function. The properties can for instance be associated with the assisting functions via a data base linking assisting functions to the properties, as properties provided as a part of the assisting function files for instance as a part of the header of the file, etc.

The properties defining one or more characteristics of the assisting function can for instance be used to provide a search function of the robot controller enabling a user to search for assisting functions based on the properties of the assisting functions. Also, the robot controller can be configured to display the properties to the user prior to the user activating the assisting function and the user can hereby decide if the assisting function should be activated. For instance, assigning functions that can be used to teach pick and place functions can be label as pick and place functions that a user can search for via the user interface. Developers developing assisting functions can also use the properties associated with assisting functions to create relationships between different assisting functions and create specified assisting functions utilizing a plurality of assisting functions. The robot controller can also be configured to display available assisting functions on the user interface based on the properties of the assisting functions and/or based on the state of the robotic system. The user interface can then be provided as a dynamic user interface that automatically displays relevant assisting functions to the user. For instance, if the gripper is open then the user interface can be configuring to display assisting functions that automatically centralize the gripper jaws between a workpiece, automatically picks up the workpiece. The robot controller can also be configured to display often used assistance functions for instance based on usage statistics of the assisting functions.

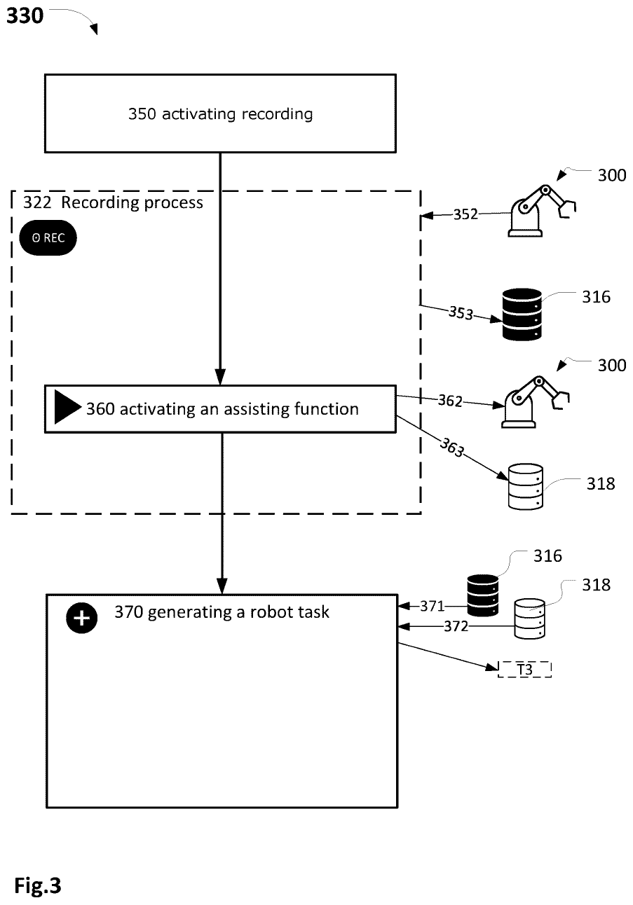

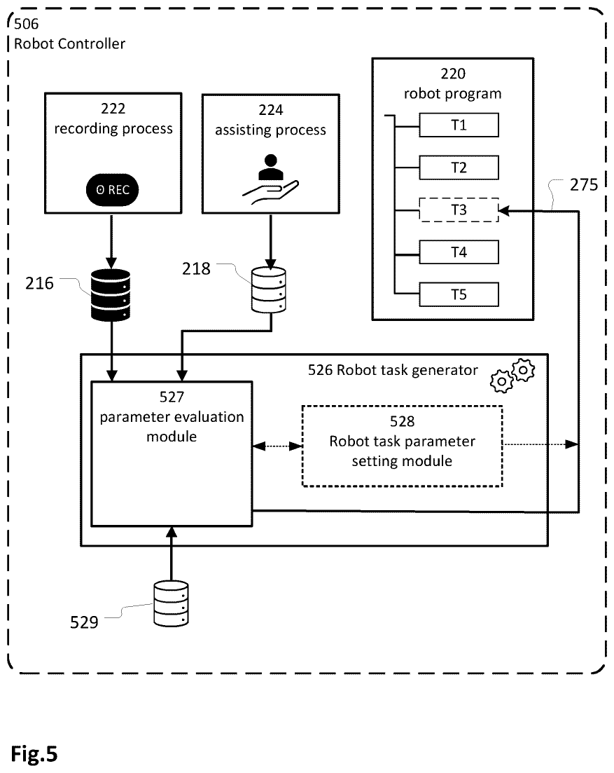

FIG. 3 illustrates a method 330 of programming a robot system 300 according to the present invention, where the robot system comprises at least one robotic arm controlled by a robot controller according to a robot program, where the robot program specifies a number of robot tasks and an order of execution of the robot tasks. For the simplicity of FIG. 3 the robot system 300 is illustrated by a single robotic arm, however it is to be understood that the robotic arm illustrated in FIG. 3 represents a robot system similar to the robot system 200, illustrated in FIGS. 2 and 5.

The method comprises a step 350 of activating a recording, a step 360 of activating an assisting function and a step 370 generating a robot task.

The step 360 of activating a recording comprises activating a recording process 322 (illustrated in dashed lines) of the robot system, where the robot controller, as described in paragraph [0039], during the recording process records 352 at least one operation parameter relating to the robot system 300 and stores 353 the operational parameter in a recording memory storage 318.

The step 360 of activating at least one assisting function is performed during the recording process 322. The activated assisting function(s) activates 362, as described in paragraphs [0040]-[0045], at least one predefined robot system action and stores 363 at least one assisting parameter relating to the activated assisting function(s) in an assisting parameter memory storage 318. In FIG. 3 the step 360 of activating the assisting function is arranged inside and performed as a part of the recording process. However, it is to be understood that the step 360 of activating of the assisting function also can be performed as a separate activating process that is executed separately and simultaneously with the recording process.

The step 370 of generating a robot task generates at least one robot task T3 based on the activated assisting function(s) and at least one of the recorded operation parameters. In the illustrated embodiment this is achieved by obtaining 371 at least one of the operational parameters recorded during the recording process from the recording memory storage 316 and obtaining 372 at least one of the assisting parameters stored in the assisting memory storage 318. The robot task T3 is then generated based on the obtained operational parameters and the assisting parameter meaning that the robot task is generated based on knowledge associated with the obtained operational parameters and the assisting parameter. For instance, the assisting parameters may indicate the kind of robot task that needs to be generated and the operational parameters may be used to set parameters of the generated robot task. As a non-limiting example, the assisting function may be an aligning function that is configured to automatically align the gripping teeth of a gripper symmetrically around an object to be picked up by the gripper. After the alignment, the assisting parameter may indicate that the robot arm shall move to the pose of the robotic arm obtained when the gripper has been aligned symmetrically around the object. A moving task is then generated which causes the robotic arm to move to an aligned pose and where the aligned pose has been obtained from the operational parameters of the robot joints when the robot arm has been aligned symmetrically around the object and the aligned pose is then provided as parameter to the moving task.

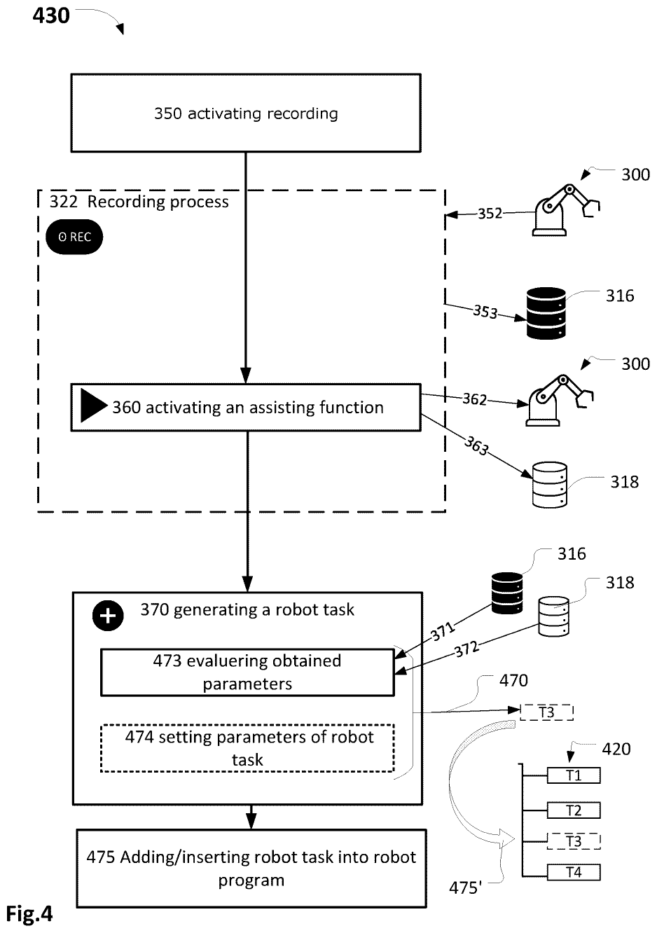

FIG. 4 illustrates a method 430 of programming a robot system 300 according to the present invention. The method 430 comprises the same steps as the method of FIG. 3 and similar steps and features have been given the same reference numbers as in FIG. 4 and will not be described further in connection with FIG. 4. In this embodiment the step 370 of generating at least one robot task comprises a step 473 of evaluating obtained parameters and a step of 474 setting parameters of the robot task.

The step 473 of evaluating the obtain parameters is based on the operational parameters and/or the assisting parameters obtained during the recording process and comprise an identification of predefined patterns of the obtained parameters, where robot task T3 is generated based on the identified predefined patterns of the obtained parameters. The identified patterns can for instance be based on values, changes of values, states, changes of states, order of obtainment, order of changes, relationship between two or more operational parameters or assisting parameters operational parameters or assisting parameters, timing of the operational parameters or assisting parameters, sequence of the operational parameters or assisting parameters etc. The predefined patterns of obtained parameters can be mapped/associated with a predefined robot task which then can be generated based on the identified pattern of obtain parameters. This makes it possible to generate relevant robot tasks for a robot program based on a user's interaction with the robot system where the user used the activation of assisting functions to indicate the intended robot task. Implementing the method according to the present invention in a robot system makes it possible to provide a robot system where a user can demonstrate the robot tasks that the robot system needs to perform by interaction and demonstrating the robot task.

The step 474 of setting parameters makes it possible to define parameters relating to the robot task which then are used to generate the robot task. Some identified robot tasks may need further inputs from the user as not all parameters relating to the obtained tasks may be demonstrated by interacting with the robot arm. Consequently, the step 472 of setting parameters can be used to define/set such parameters. For instance, if the user has demonstrated a robot task in form of a movement of the robotic arm, the user may desire to specify a specific moving speed instead of just replicating the recorded moving speed of the robotic arm obtained during the recording process. Also, in case the step 473 of evaluating the obtained parameters results in two possible robot tasks matching the obtained parameters then the user can specify the intended robot task by setting parameters of the robot task. It is noted that the step 474 of setting parameters is an optional step of the method and thus illustrated in dotted lines.

Consequently, the robot task T3 can be generated based on the step 473 of evaluating the obtained parameters and optionally also the step 474 of setting parameters of the robot task as illustrated by arrow 470.

In this embodiment the method comprises a step 475 of adding/inserting the generated robot task T3 into the robot program 420 as illustrated by arrow 475′. The user can for instance indicate where in the robot program the generated robot task shall be inserted.

It is noted that the method also can comprised additional steps of setting parameters of the robot task. For instance, a user may after the robot task has been added/inserted into the robot program be able to select the robot task and set or update parameters of the robot task.

FIG. 5 illustrates an embodiment of a robot controller 506 of a robot system according to the present invention. The robot controller is like the robot controller 206 of FIG. 2 and similar features and elements have been given the same reference numbers as in FIG. 2 and will not be described further. Also, it is to be understood that the robot control 506 is configured to control a robot system and interact with a user as described in FIG. 2, however the user and the robot of the robot system have been omitted for simplicity of the figure.

The robot task generator 526 is, like the robot task generator 226 shown and described in FIG. 2, configured to generate at least one robot task T3 based on the assisting function executed by the assisting process 224 and at least one of the operation parameters recorded by the recording process. In other words, the robot task generator is configured to generate robot program code which can be added/inserted into the robot program as illustrated by arrow 275. The robot task generator 526 comprises a parameter evaluation module 527 and a robot task parameter setting module 528.

The parameter evaluation module 527 evaluates the operational parameters and the assisting parameters respectively obtained by the recording process 222 and the assisting process 224 in order to identify a robot task based on the operational parameters and/or the assisting parameters. In the illustrated embodiment the parameter evaluation module 527 obtains the operational parameters and the assisting parameters respectively from the recording memory storage 216 and the assisting parameter memory storage 218, however the parameter evaluation module can also receive the parameters directly from the recording process and/or the assisting process or any other storage or process. The parameter evaluation module is configured to identify the robot task by identifying predefined patterns of the operational parameters and the assisting parameters, where the predefined patterns are associated with the robot task. The robot controller comprises a pattern and robot task storage 529, where in a number of predefined patterns of the operational parameters and/or assisting parameters are stored and where the predefined patterns of operational parameters and/or the assisting parameters are associated with at least one robot task. The parameter evaluation module 527 is configured to compare the pattern of the obtained operational parameters and/or the assisting parameters with the predefined patterns of operational parameters and/or the assisting parameters stored in the pattern and robot task storage 529 and generate the robot task based on the robot tasks associated with the identified pattern of operational parameters and/or assisting parameter. The predefined patterns can for instance be based on values, changes of values, states, changes of states, order of obtainment, order of changes, relationship between two or more operational parameters or assisting parameters, timing of the operational parameters, or assisting parameters, sequence of the operational parameters or assisting parameters etc. The identification can be based on any method suitable for comparing data and parameters and a positive identification can be provided if such method provides sufficient confidence. This makes it possible to generate relevant robot tasks for a robot program based on a user's interaction with the robot system where the user used the activation of assisting functions to indicate the intended robot task. Further the activated assisting functions can assist the user providing the correct demonstration of the intended robot task.

The robot task generator comprises a robot task parameter setting module 528 configured to set at least one parameter of the generated robot task. The robot task parameter setting module 528 makes it possible to define parameters relating to the robot task which then are used to generate the robot task. Some of the identified robot tasks may need further inputs from the user as not all parameters relating to some of the identified tasks can be demonstrated by interacting with the robot arm. Consequently, the robot task parameter setting module 528 can be used to define/set such parameters. For instance, if the user has demonstrated a robot task in form of a movement of the robotic arm, the user may then utilize the robot task parameter module 528 to specify a specific moving speed instead of just replicating the recorded moving speed of the robotic arm obtained during the recording process. Also, in case the parameter evaluation module results in two possible robot tasks matching the obtained parameters then the user can utilize the robot task parameter setting module 528 to specify the intended robot task by setting parameters of the robot task. The robot task parameter setting module can thus be utilized together with the parameter evaluation module as illustrated by arrow 574a of setting parameters of the robot task. This is for instance usefully if the user after the demonstration wants to specify certain parameters the determines what kind of robot task that shall be generated. It is noted that the arrow 574a is a two-way arrow as the parameter evaluation model 527 also can be configured to request setting of robot task parameters. This is useful if the parameter evaluation module needs further inputs from a user in order to generate the robot task. The robot task parameter setting module can also be configured to set the robot task parameters after they have been generated by the parameter evaluation module. This enables that the user can change and/or set parameters of the robot task after the robot task has been generated, whereby the user also can modify eventual parameters of the robot task. The robot task parameter is an optional step of the method and thus illustrated in dotted lines.

In one embodiment the robot task parameter setting module 528 can be configured to define and or set executing parameters relating to the robot task generated by the parameter evaluation model, where the executing parameter defines a mode of execution of the related robot task. This makes it possible to set the tolerance and adaptiveness of the robot task and robot program. The tolerance and adaptiveness of the robot task is an indication on how well the robot system adapt to changes in the robot system. The more tolerant and adaptive the robot program is the smaller probability of failure of the robot program during execution. However, a typical consequence of a more tolerant and adaptive robot program is a reduction of cycle time. The execution parameter can for instance indicate if a robot task shall be executed every time a certain robot task is executed; if a robot task shall be executed only the first time the robot task is executed, indicate an interval (time/numbers) at which the robot task shall be executed. Also, in case that the assisting function causes the robotic arm to perform a predefined action resulting in identification of a certain operational parameter of the robot system then the execution parameter can indicate whether the robot task shall comprise parts of the executed action or only be based on the identified operational parameters.

As an example, the assisting function may be a search function where the robotic arm automatically identifies the center of a hole in a workpiece, e.g. a hole for an insertion of an object. The user utilizing the assisting function can then choose if the search function shall form part of the generated robot task or if only the coordinates of the center of the hole identified during demonstration shall form part of the robot task. If the user chooses that the robot task shall comprise the search function, then the search function will be executed every time the robot task is executed by the robot program, while if only the coordinates of the center of the hole have been added to the robot task, then the search function will not be executed during the robot program. The result is that in the first instance a more tolerant and adaptive robot program can be provided, as the robot system will be less sensitive to changes in the position of the workpieces as the center of the hole is automatically identified. However, the execution time of the robot program of the first instance is slower than the second instance as the search function needs to be performed every time the center of the hole needs to be identified. The second instance thus provides a faster robot program as the robot task is only utilizing the center of the hole identified during the demonstration, which in some situation will be preferred, especially if the workpieces are arranged at the same position every time the robot task is generated.

As another example, the assisting function may be an alignment function that aligns the gripper with the workpiece to be gripped, such that the workpiece is centralized between two gripping jaws of a gripper. The assisting alignment function may comprise the following steps:

1) Manually placing the gripper above the workpiece, by setting the robotic arm into free drive such that the user manually arranges the gripper in a position above the workpiece and with the gripping jaws pointing towards the workpiece. It is to be understood that the user also can use control bottoms on a user interface to move the gripper. The position can be recorded as a start position, Start_Position.

2) Automatically closing the jaws of the gripper.

3) Automatically moving the gripper towards the upper surface of the workpiece until the tip of the jaws gets in contact with the upper surface of the workpiece, this can for instance be done by utilizing the methods described in WO 2020/239081 titled “Detection of change in contact between a robot arm and an object”. The position at contact can be recorded as an upper contact position, Upper_Position.

4) Automatically retracting the gripper a predetermined distance, Retract_Distance, upwards from the upper surface from the workpiece, as this with enable opening of the gripper without conflicting with the workpiece.

5) Automatically open the gripper.

6) Automatically move the gripper a predetermined distance downwards Approach_Distance, such that the jaws are placed at the sides of the workpiece.

7) Automatically move the gripper sidewards in a first direction until the first jaw gets in contact with the workpiece. The position at contact can be recorded as a first jaw contact position, Jaw1_ContactPosition.

8) Automatically move the gripper sidewards in a second direction opposite the first direction until the second jaw gets in contact with the workpiece. The position at contact can be recorded as a second jaw contact position, Jaw2_ContactPosition.

9) Automatically align the gripper with the workpiece arranged centrally between the two jaws based on the first jaw contact position and the second jaw contact position. The position at the alignment can be recorded as center gripping position, Gripper_CenterPosition.

10) Automatically move gripper to the center gripping position.

11) Automatically close the gripper

12) Semi-automatically retract the gripper with the workpiece a distance upwards, by setting the robotic arm into lock axis free drive where the user manually can move the gripper along a fixed vertical axis and thereby arrange the gripper and workpiece in a position above the pickup location. The final position of the of the retraction can be recorded as an exit position, Exit_Position.

The parameter evaluation module 527 generate robot code based on the assignment function and recorded parameters. As an example, the program code may be represented by the following pseudo program code.

| | |
|---|---|
| 01: | Move to Start_Position |
| 02: | Close Gripper |
| 03: | Move Gripper downwards until contact |
| 04: | upon contact store actual position as Upper_Position |
| 05: | Move Gripper upwards the distance: Retract_Distance |
| 06: | Open Gripper |
| 07: | Move Gripper downwards the distance: Approach_Distance |
| 08: | Move Gripper sidewards in a first direction until contact |
| 09: | upon contact store actual position as Jaw1_ContactPosition |
| 10: | Move Gripper sidewards in a second direction until contact |
| 11: | upon contact store actual position as Jaw2_ContactPosition |
| 12: | Set: Gripper_CenterPosition = |
| | (Jaw1_ContactPosition+Jaw2_ContactPosition)/2 |
| 13: | Move Gripper to Gripper_CenterPosition |
| 14: | Close gripper |
| 15: | Move to Exit_Position |

The pseudo program code comprises 15 program commands that during operation of the robotic arm can be executed by the robot controller. The user set the tolerance and adaptiveness of the robot program by specifying which of the 15 program commands that shall be executed by the robot controller during operation. This can for instance be done via the task parameter setting module 528 which can be configured to allow the user to specify that all program codes need to be executed for every program cycle, resulting in a tolerant and adaptive execution of the robot task, as the gripper in each program cycle identifies the upper surface of the workpiece to be gripped and automatically centralizes the gripper jaws in relation to the workpiece before gripping it. Such an implementation is for instance useful if the height of the workpiece and the gripping position of the workpiece varies between each operation cycle.

A less tolerant and adaptive robot program can be provided by specifying that the program codes 02, 03, 04, 05 not shall be executed during the operation of the robotic arm, and that the start position parameter, Start_Position is modified to be equal to the position of the upper surface, Upper_Position, after the gripper has been moved the retraction distance Retract_Distance. This corresponds to a robot command:

$$Set : Start\_Position = Upper\_Position + Retract\_Distance$$

However, this robot command only needs to be performed as apart of the teaching process as the start position, Start_Position, is predefined before executing the robot code. In such embodiment the robot task will be performed by executing robot codes: 01, 06, 07, 08, 09, 10, 11, 12, 13, 14 and 15 resulting in a faster program cycle as the robotic arm does not identify the upper surface of the workpiece before gripping it. This process is useful when the height of the workpiece is the same between each operation cycle but where the gripping position of the workpiece varies between each operation cycle.

Another and less tolerant and adaptive robot program can be provided by specifying that the program codes 08, 09, 10, 11, 12, 13 not shall be executed during the operation of the robotic arm and that the start position parameter, Start_Position, is modified so that it is aligned with the center gripping position, Gripper_CenterPosition, obtained during the teaching process. For instance in an embodiment where the X-axis and Y-axis form a plane onto which the workpiece is arrange the (X,Y)-coordinates of the start position can be set to equal the (X,Y)-coordinates of the center gripping position for instance by the robot commands:

$$Set : Start\_Position ( X ) = Gripper\_CenterPosition ( X )$$

$$Set : Start\_Position ( Y ) = Gripper\_CenterPosition ( Y )$$

These robot commands only need to be performed as a part of the teaching process as the start position, Start_Position, is predefined at a position centralized in relation to the workpiece before executing the robot code. In such embodiment the robot task will be performed by executing robot codes: 01, 02, 03, 04, 05, 06, 07, 14 and 15 resulting in a faster program cycle as the robotic arm does not identify the center of the workpiece before gripping it. This process is useful when the workpieces are arranged at the same gripping position and where the height of the workpieces varies between each operation cycle.

An even faster operation cycle can be obtained by combining the program cycles described in paragraphs [0076] and [0077] where only program codes 01, 06, 13, 17 and 15 are to be executed with each operation cycle. This process is useful if the height and gripping position is the same for each operation cycle and it is possible to obtain a faster cycle time.

It is to be understood that the skilled person will be able to provide many different variants of how the program code can be adapted as desired by a user, for instance the entire program of paragraph [0074] may be performed the at the first operation cycle in order to automatically identify the start position and the center gripper position, where after the program cycle may be executed as process of paragraph [0078]. Also, the robot program can be configured to perform the height and/or the position identification if the workpiece is changed.

The user can thus set the level of fail tolerance and optimal execution, which for instance can be defined as at least three levels of fail tolerance vs optimal execution:
1. The generation of tasks based on the demonstration is done in the less time-consuming version. Like a fixed waypoint instead of a search for contract motion.
2. The generation of the tasks is generated in a way so the first and most risky execution time is done in a tolerant way and first after the task have been verified, the verified information is used to make a default efficient variant of the program. Like first probed the height with a search for contact motion. For in the next run visiting the same position with a direct move towards the probed height.
3. Always use the tolerance version to have the most robust program that potentially can adapt to changes in the environment during execution.

All types can improve their robustness by adding a try-catch strategy. Where the tasked have defined how the quality of the performed action be validated and what to do in case of an invalid performance. This strategy can be together with a task structure that can return the performance status to an overlayed structure that can e.g., make the task retry a number of times and/or skip the grid point and go the next etc.

In one embodiment the robot system can comprise an enabling device, e.g. a 3 positional enabling device button, which can be used to control the execution of the robot program as well as be the safety device at the same time. An example of this could be that the operator starts an action. And as long the user holds down the 3 positional enabling device buttons in active state that enable the robot to run. The action will be performed. But if the operator disables the button, the robot will pause the motion. Though continue if the operator enables the button again if possible or do a defined reset or cancel the action if the user has regret it. It is possible to regret and start another action. This could be done simply by selecting another action.

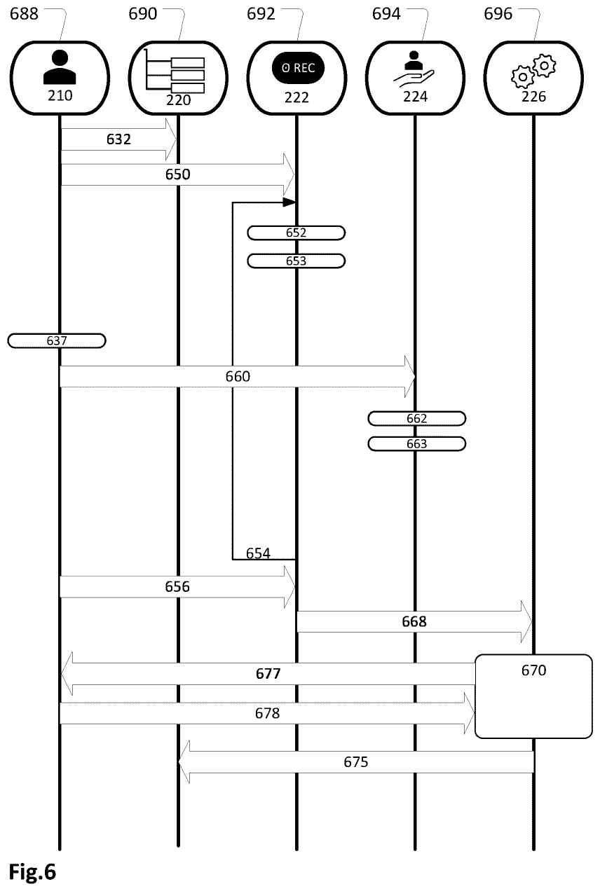

FIG. 6 illustrates a sequence diagram of the method of programming the robot system when carried out utilizing the robot system according to the present invention and exemplified by the robot system of FIG. 2. Sequence 688 illustrates the interactions and steps involving the user 210, sequence 690 illustrates the interactions and steps involving the robot program 22, sequence 692 illustrates the interactions and steps involving the recording process 222, sequence 694 illustrates the interactions and steps involving the assisting process 224 and sequence 696 illustrates the interaction and steps involving the task generator.

The sequence starts by the user 210 selecting 632 a position in the robot program 220, where the position indicates where the robot task that the user is about to demonstrates shall be inserted into the robot program.

Thereafter the user activates 650 the recording process which then, as describe previously, starts to record 652 operational parameters of the robot system and stores 653 the operational parameters in a memory. The recording 652 and storing 653 process are repeated in a continuous recording and storing loop 654 as illustrated by dotted arrow.

While the recording process is running the user starts to interact 637 with the robot system in order to demonstrate the intended robot task, and the interaction involves the user activating 660 an assisting function of the assisting process 224. The assisting process 224 will then activate and execute 662 the robot system action associated with the activated assisting function and also store 663 assisting parameters associated with the activated assisting function. That the user can activate a plurality of assisting functions during the demonstration of the robot task and steps 660, 662 and 663 are thus repeated for every activated assisting function.

Once the user is done demonstrating the intended robot task the user deactivates the recording process 656 and the task generator 226 is automatically notified 668 that the user's demonstration is completed. In the illustrated embodiment the task generator 226 is notified by the recording process 222. However, it is to be understood that the user or other parts of the robot system can notify the task generator 226 that the demonstration has been completed. The task generator can then generate 670 the robot tasks and can as part of the generation request 677 and/or receive 678 inputs from the user which can be used to setting parameters of the robot task as described previously.

Once the robot task has been generated by the robot task generator 226 the robot task generator can add/insert 675 the robot task into the robot program at the position indicated in step 632.

It is to be understood that the illustrated sequence diagram shows an example of a possible sequence flow and that variations of sequence flows can be made by the person skilled in the art.

The following paragraphs describes examples of different assisting functions which upon activation activates at least one robot system action which can be utilized to demonstrate a robot task.

Alignment assisting functions are assisting functions which upon activation automatically align a part of the robotic arm, such as the tool flange or the tool center point (TCP) of an end effector, to a feature or object of the robot system. The robot system action thus results in movement of the robotic arm in order to align a part of the robotic arm with the feature or object. The assisting parameters associated with the alignment assisting function can be an indication of the end pose of the robotic arm when it has been aligned with the feature or object. However, the assisting parameter can also indicate the start pose of the robot arm before alignment. Alignment assisting functions can assist the user during the demonstration to ensure accurate and/or precise alignment of the robotic arm with the feature or object. This is an advantage as experience has shown that the user is bad a demonstrating accurate pose of the robot arm during demonstrations, and the use of alignment assisting functions can utilize the sensor and accurate positioning of the robotic arm to provide accurate demonstration of poses of the robotic arm.

Move into contact assisting functions are assisting functions which upon activation moves the robotic arm in a predetermined direction or moving pattern until the robotic arm detects that it come in contact with a feature and/or object of the robotic system. The contact can be detected by utilizing various sensor devices of the robotic system as known in the art. The assisting parameters associated with move into contact assisting functions can indicated the direction or moving pattern utilized by move into contact assisting function, for instance the user can select the direction or moving pattern when activating the move into contact assisting function. Further the assisting parameter can indicate the pose of the robotic arm when the contact point has been detected. Move into contact assisting functions are useful as they can be used by the user to demonstrate precise contact points which can be used to map features of the robot system or as reference points in the robot program. The assisting parameter can also indicate if the move into contact function shall form part of the generated robot task such that the robot system will perform a move into contact function every time the generate robot task is executed during operation of the robotic system. As described above this makes it possible for the user to utilize the assisting functions to modify and design how tolerant and/or optimized the robot program shall be.

Undo assisting functions are assisting functions which upon activation causes the robot system to return to previous states based on the recorded operational parameters. A user demonstrating a robot task that during the demonstration session wants to re-demonstrate a part of the robot task can then use undo assisting functions to return to a previous state of the robot system. This can be done by recording all operational parameters indicating the state of the robot system in different time steps in a data base and then bring the robot system backwards in time by sequentially setting the operational parameters of the robot system to the recorded values backward in time. Once an undo assisting function have been activated a redo assisting function can also be activated, where the redo assisting function brings the robot system to a previous state that timing wise have occurred after the previous state to which the robot system has been brought using undo assisting functions. In other words, the undo and redo assisting functions can be used to rewind and forward the state of the robot system. This is very useful when demonstrating and testing the demonstrated robot task.

The method and robot system according to the present invention can also utilize passive assisting functions which can be used to change status of parts of the robotic system, and which is not configured to execute a robot action upon activation.

The following paragraphs sections describes different scenarios, where a user utilizes the robot system and method according to the present invention to demonstrate a robot program to be performed by the robot system.

Scenario 1: Pick and Place into Grid

This scenario shows how a user can instruct a robot system to pick an object from a fixed location and place that into a grid (e.g., conveyor to pallet). Once the user has activated the recording process, the user may apply the following subset of available assisting functions in the following sequence of user applied assisting functions:
1. Free-drive
2. Align to Z
3. Move into Contact
4. Center to Object
5. Close Gripper 1
6. Retract
7. Free-drive
8. Grid
9. Align to Z
10. Move Into Contact
11. Open Gripper 1
12. Retract
   The assisting functions used in this scenario are defined as described in the paragraphs below.

### Free Drive

This assisting function is an example of a passive assisting function, as it only puts the robotic arm into the known free-drive mode of operation without executing robot actions. In free-drive mode of operation the pose of the robotic arm can be change by applying an external force to the robotic arm and where the robotic arm is kept in a static pose when only gravity is applied to the robotic arm. When the free-drive assisting function is activated the user is allowed to change the position of the robotic arm for instance by moving the tool flange from one position to another position. The free-drive assisting function can be associated with various setting parameters which can be used to further assist the user during the free-drive mode. For instance, a locked axis setting parameter can indicate of any of the degrees of freedom (DOF) of the robot tool flange shall be locked during the free-drive move of operation. Locking of degrees of freedom can for instance help the user performing a demonstration in free-drive to keep a desired orientation of the tool flange. Additionally, an assisting parameter associated with the free-drive assisting function can indicate if positional operational parameters obtained during the free-drive mode of operation should be used to generate a robot task defining movement of the robotic arm. The robot task generator will in that case convert the recorded positional operation parameters into one or more robot tasks defining movement of the robotic arm.

### Align to Z

This assisting function enables the user to align the robot tool (end effector or tool flange) to any frame selected by a frame id or by providing a 6 DoF vector representing a frame. At teach time, if no frame is provided, the robot will automatedly touch-up the plane in immediate extension of the robot's tool's Z direction in order to assist the user defining the plane. This the robot task generator takes the assisting function and inserts its script code directly in the resulting robot system program, propagating any potential parameters into the user interface for the user to adjust. The user can choose if the robot should be touching-up the plane on each iteration of the robot system program or only during teach time.

Move into Contact

This assisting function utilize the robotic arm's contact detection functionality, or another signal indication of a contact between the robotic arm and a feature and/or object of the robot system, together with a relative movement in the given direction. By default, this direction can be the Z direction of the Tool Center Point's, but the user may change this. This movement will continue until the robot system registers a contact. The assisting function can be associated with various settings specifying how the assisting function is carried out by the robot system. For instance, settings such as contact parameters, move direction, move distance, move velocity, move acceleration, blend radius, frame reference, fixed or relative.

The robot task generator can generate the robot task (robot code) by using the same action and parameters that was used in the demonstration, and the robotic arm will during execution perform a move into contact task as demonstrated, making the robotic arm search for a contact in the given parameters like direction to make the execution tolerant to changes in the task and e.g., search for.

Alternatively, the robot task generator can use the recorded data to make a move to a fixed, parameter define, frame or relative move function moving in the same direction and distance as it was recorded in the demonstration. In the execution, the fixed position, the robot task generator uses the recorded stop position as the resulting move target. The relative move calculates the move target position from the, at execution time, current position and added difference between the recorder stop and start position. This assisting function is good to make efficient moves towards a fixed object as the contact function has identified the distance to move.

### Center to Object

A center to object assisting function utilizes a gripper attached to the tool flange and a force-torque sensor of the robotic arm to determine the location of the center point of object. Prior to activating this assisting function, the robotic arm is arranged such that the object, which center point shall be determined, are positioned between the fingers of the gripper. The assisting function then causes the robotic arm to move linearly (in cartesian space) in the XY plane spanned by the tool center point of the robotic arm until a user-defined force has been detected by the force torque sensor. Subsequently the robotic arm is moved in the opposite direction to find the contact point of the other gripper finger. For three finger grippers the assisting function rotates the robot's tool in between contact detections to ensure that all finger contact points are detected. The assisting parameters can indicate the positional operation parameters of the robotic arm upon each of the detected contacts or the assisting function can be configured to calculate the center point based on the operation parameters. The center point assisting function can also be associated with assisting setting parameters to use during the execution of the assisting function and they can for instance specify force threshold for detecting contact and or changing direction of movement, velocity, maximum radius, and number of fingers of the gripper.

The robot task generator can for instance utilize the same evaluation as the align to z assisting function and enable the user to choose if the robotic arm shall perform the center to the object function at every robot cycle of the robot program or only during teach time and then use the learned positions as position parameters during execution of the robot tasks.

### Gripper Toggle

A gripper toggle assisting function toggles the state of an attached gripper from e.g., close to open or open to close. If the gripper state is unknown at demonstration time, it executes a gripper movement that releases the grasp. So, depending on the type of grasp, an inside-out grasp moves the gripper fingers closer to each other. And for an outside-in grasp it moves the fingers away from each other. The gripper toggle assisting function can be adjusted by a number of assisting settings such as the gripper to use, max open position, max close position, gripper vendor parameters (like force, velocity, acceleration), payload parameter for close position, payload parameter for an open gripper, type of grasp. The associated recorded operational parameters can be operational parameters such as: Recorded parameters: Gripper state, Gripper finger position, Gripper force.

The robot task generator uses the resulting gripper positions and state to generate robot tasks that moves the gripper to the position or properties defined in the parameters like, grasping force.

The robot task generator can be configured to provide grasping quality functionalities to the robot task during execution of the robot program and can validate that the e.g., grasp position and force does match the recorded one during the demonstration, with some tolerances. If the quality is too low the system could e.g., set the program to a pause and ask for a user action or return the status to another function handling e.g., a retry, try the next grid position or another error handling strategy or a combination of multiple. The robot task generator can also be configured to name the robot take based on the gripper state to make the program in text that the action is doing. E.g., “Closing gripper 1” or “Open gripper 2.” Also, the robot task generator can be configured to generate a robot task that changes the payload setting of the robot arm, as typically when the gripper closes the gripper is grasping a mass, a center of mass, and/or inertia of the payload setting can be changed. If the cycle is important the robot task generator use the recording from the demonstration and/or the knowledge from already executed program sequence to optimize the gripper parameters, like opening position, to e.g., minimize the time it takes to close and open the gripper and thereby optimize the robot system cycle time.

### Retract

A retract assisting function is configured to move the robotic arm a distance until it is stopped, or it reaches the max distance. By default, this is set to move the robotic arm in the Z-direction of Z of the TCP to make it easy to retract from e.g., placing an object with a gripper. This assisting function can be associated with assisting settings like: Move direction, move distance, move velocity, move acceleration, blend radius.

The robot task generator uses the recorded operational parameter such as start position and end position of the TCP upon activation of the retract assisting function to make a relative move function moving in the same direction and distance as it was recorded in the demonstration. In the execution, the relative move can be calculated from the, at execution time, current position and calculated from that starting point towards end point resulting in the motion that e.g., will move 10 cm in the minus Z direction if there is 10 cm different between the recorded start and stop position in the minus Z direction.

### Grid

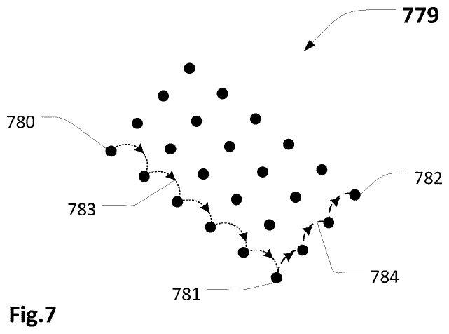

A grid assisting function is configured to execute a robot system action in form of instructions to the user. The instructions can for instance be provided in form of instructions on a display of the user interface and/or auditable instructions provided by a loudspeaker. An example of a demonstration of the grid is illustrated in FIG. 7 illustrating a grid 779 of positions (black dots) that the robotic arm shall visit during the robot program. Initially the grid assisting function sets the robotic arm into free-drive mode of operation as described previously and then provide instructions to the user to first demonstrate the grid positions of the first row by moving the TCP of the robotic arm sequentially from the start grid position 780 to the last grid position 781 of the first row as illustrated by the dotted arrows 783. Further the grid assisting function instructs the user to demonstrate the grid positions of the last column moving the TCP of the robotic arm sequentially from the last grid position 781 of the first row to the last grid position 782 of the last column as illustrated by arrow 784. The assisting parameter of the grid assisting function indicates the movement operational parameters of the robotic arm shall be recorded.

The robot task generator generates a robot task ensuring that the robotic arm visits the grid positions of the grid by looking for local minima in the recorded movement operational parameters in order to establish the outskirt grid point locations. Afterwards the robot task generator establishes the rest of the grid points by estimating the intersections between the row and column outskirt points. In addition, an approach position is extracted by the robot task generator using the recorded robot system parameters to avoid collisions in the motion to the grid points. This approach position can later be adjusted by the user. The resulting code is a lookup table of points, an iterator and two waypoints.

Alternatively, the grid assisting function can instruct the user to demonstrate the grid by first moving the TCP of the robotic arm to the start corner. Once the user has moved the TCP to the start corner, the user confirms the position via the user interface, and the grid assisting function provides instructions instructing the user to move the TCP to the next grid position. The user then moves the TCP to the next grid position and confirms this via the interface. This is repeated until the last grid position of the first row have been reached and the user can then provide instruction that this position have been demonstrated. The grid assisting function the provided instructions to move the TCP to the last grid position of the second row and when the user confirms this position once the TCP have been moved to this position. This is repeated until the last grid position has been confirmed by the user. The user then moves the TCP to the next grid position and confirms this via the interface. This is repeated until the last grid position of the first row have been reached and the user can then provide instruction that this position have been demonstrated. The grid assisting function the provided instructions to move the TCP to the last grid position of the second row and when the user confirms this position once the TCP have been moved to this position. This is repeated until the last grid position has been confirmed by the user. In other words, the user first demonstrates the grid positions of the first row followed by the grid positions of the last column as illustrated by arrow 783. The assisting parameters of the grid assisting function indicates to positions of the demonstrated grids. The robot task generator can then generate the robot task based on the grid positions confirmed by the user.

The robot program of the robot tasks generate by the robot task generation based on the users demonstration and activation of assisting functions of scenario 1 can be for instance be provided as the exemplary robot code provided in PolyScope program nodes, as known form the programming interface of robotic arms provided by Universal Robots:

```
Program
  Robot Program (Loop)
    MoveL
        Waypoint_1
        Waypoint_2
        Waypoint_3
        Waypoint_4
        Waypoint_5
    AlignToZ(frame=’base’)
    MoveIntoContact(force=5, max_distance=0.1)
    CenterToObject(...)
    Gripper(cmd=’close’, force=100)
    Retract(axis=’z’, distance=0.1)
    MoveL
        Waypoint_6
        Waypoint_7
    Grid
      GridPoint = GetNextGridPoint(gridIterator)
      gridIterator += 1
      MoveJ
        ApproachPoint
      MoveL
        GridPoint
    AlignToZ(frame=’base’)
    MoveIntoContact(force=5, max_distance=0.1)
    Gripper(cmd=’open’, force=100)
    Retract(axis=’z’, distance=0.1)
```

### Scenario 2: Using Peripheral Equipment to Activate Assisting Function

This scenario describes how a user can instruct a robot system to dispense a fluid by dispensing end effector, such as sealant, using a peripheral device input device connected to the robot system control box through standard I/O. The peripheral input device is configured to activate an assisting function of the robot system and can for instance be an on/off foot pedal switch, but it is noted that it could be any kind of I/O device connected to the robot system.

The user applies the following subset of available assisting functions in the following sequence:
1. Free-drive
2. Prime Dispenser
3. Free-drive
4. Dispense triggered by I/O from Foot Pedal

The activated free-drive assisting functions are like the free-drive assisting function describe previously and the two other assisting function are described further in the following paragraphs.

### Prime Dispenser

Prime Dispenser assisting function that starts priming the dispensing end effector attached to the robotic arm, meaning that the dispensing end effector is preparing to dispense fluid. For instance, the sealant may need to be heated before the dispensing end effector can dispense the sealant. When the user have activated the prime dispenser assisting the robot task generator adds a robot task to the robot program they would result in priming of the dispenser.

### Dispense

The dispense assisting function is a superset of two underlying assisting functions: a free-drive assisting function and activation of I/O assisting function. Upon activation it sets the robot in free-drive so the user can move the dispensing tool-placed at the end of the robot-through the trajectory of where the sealant should be applied. With the foot pedal the user controls when the dispensing tool is activated while demonstrating the motion that the robot should follow in execution mode. The assisting parameters then indicates when the user has activated and de-activated the input device.

The Robot task generator uses recorded motion operational parameters of the robot arm to create a speed-based motion that moves the robot at the same speed as demonstrated and use the assisting parameters to indicate where in motion the dispensing device shall dispense the fluid. This ensures that the same amount of sealant is applied during execution as was applied during demonstration. The dispensing tool is activated and deactivated at the same points in time as during the demonstration, so sealant is applied the same places during execution. The generated robot task is thus a dispensing robot task whish moves the robotic arm along the demonstrated trajectory and starts the dispensing end effector at the positions indicated during the demonstration.

This demonstration may result in the exemplary robot program code provided in PolyScope program nodes as known from the programming interface of robotic arms provided by Universal Robots:

```
Program
  Robot Program (Loop)
    MoveL
        Waypoint_1
        Waypoint_2
      PrimeDispenser
    MoveL
      Waypoint_3
    Dispensing
```

Scenario 3: User Flow when an Error Occurs During Demonstration (Undo/Redo)

During demonstrations the human operator is prone to making errors. To remove the need for redoing complete demonstration sessions an undo/redo capability is present. Thus, the user can undo the assisting functions one-by-one until the desired state in the demonstration has been reached. When the robot system is asked to undo its latest action, the robot will default to reversing the trajectory it had just carried out. In addition to this, each assisting function can provide a method for undoing its action. Consider the scenario where a user has moved a robot in position to grasp an object, the user activates the assisting function to close the gripper, but the grasp results in the object being crooked in the gripper. The user does not like this and wants to undo this action. The assisting function used for the gripper provides a rule-based undo/redo method that carries the previous and current state of the gripper. When the user activates the undo method through the user interface, the gripper will release the object as it knows the difference between its previous and current state. If the user regrets undoing the assisting function, the user can redo it resulting in the assisting function being executed again. In this way the undo and redo functions can also be used to test and verify a single or multiple demonstrated tasks.

Scenario 4: Custom Wizard Flow from Previous Recordings

This scenario describes how user A can use the proposed method(s) to program a robot system sequence to then later let user B rerecord the robot system parameters without complete knowledge of the robot system application. The concept lets user A define which of the applied assistant functions in a previous demonstration to be rerecorded by excluding a subset of these. Furthermore, user A has the option to give comments to each assisting function. The comment is displayed to user B during rerecording. User B selects the sequence previously programmed by user A and selects the option to rerecord the sequence. Upon selection user B is prompted to click “next” to execute the first assisting function in the selected sequence. Upon confirmation user B is presented with the message previously provided by user A which may instruct the user to take a plurality of actions with the robot system while the corresponding assisting function is executed with the original set of assisting function parameters. User A and user B may be the same person.

A scenario of this could be the mentioned sequence in scenario 1, that first have been performed by user A during programming of the robotic system and where a user B at a later point in time needs to reprogram the robotic system, e.g., if the objects to be moved and/or grid proportions changes.

Sequence of user applied assisting functions:
1. Freedrive, Rerecord: True, Note: ‘Move robot to part location’
2. Align to Z, Rerecord: True, Note: ‘Makes sure robot is aligned’
3. Move into Contact, Rerecord: True, Note: ‘Control gripper height’
4. Center to Object, Rerecord=True, Note: ‘Control gripper is center’
5. Close Gripper 1, Rerecord=True, Note: ‘Control grasp’
6. Retract, Rerecord=True, Note: empty
7. Freedrive, Rerecord=True, Note: ‘Move robot to grid’.
8. Grid, Rerecord=False
9. Align to Z, Rerecord=False
10. Move Into Contact, Rerecord=False
11. Open Gripper 1, Rerecord=False
12. Retract, Rerecord=False
   User A has demonstrated a program as in scenario 1. To facilitate frequent changes in the part pickup location, User A prepares the demonstration for rerecording by enabling the functionality on program tasks 1-7 and adding descriptions for user B.

User B is tasked with changing the robot program of user A to compensate for a new part location. User B executes the rerecording set up by user A. The robot system will start to execute the subset of chosen assisting functions. Upon each confirmation of an assisting function the robot system will execute the next assisting function automatically. By nature of the assisting functions some might need user input such as hand-guiding or parameters and others may execute directly without further input. User B walks through the following steps:
1. In step 1 user B hand-guides the robot to the new part location and confirms completion by pressing a software button on the teach pendant or using a hardware input assigned to the confirmation.
2. The robot aligns the TCP Z axis to the base Z axis. User B provides no further input than confirmation of completion.
3. The robot moves directly into contact with the surface of the part location. User B visually confirms and continues.
4. The robot centers the gripper to the part. User B visually confirms and continues.
5. The gripper activates to a closing state. User B confirms that the part is firmly set in place and continues.
6. The robot retracts in the Z direction of the TCP. User B confirms. No inspection is needed.
7. User B hand-guides the robot from the new part location to the grid.

Upon completion of rerecording the subset its corresponding program parts are automatically updated with new robot system parameters leading to a new evaluation hereof consequently changing the program execution to handle the new part location.

The illustrated embodiments only serves to illustrate the concepts of the present invention and it is to be understood at the person skilled in the art may be capable of providing many different embodiments within the scope of the invention. Further it is to be understood that the illustrated embodiments can be combined and also it is to be understood that the assisting functions can be combined in at many different programming scenarios.

BRIEF DESCRIPTION OF FIGURE REFERENCES

| | |
|---|---|
| 100, 200, 300 | robot system |
| 101, 201 | robot arm |
| 102a-102f | robot joint |
| 103 | robot base |
| 104 | robot tool flange |
| 105a-105f | robot joints axis |
| 106, 206 | robot controller |
| 107 | interface device |
| 108 | display |
| 109 | input device |
| 210 | user |
| 211 | gripper |
| 212 | conveyer belt |
| 213 | box |
| 214 | pickup location |
| 215 | pallet |
| 216, 316 | recording memory storage |
| 218, 318 | assisting parameter memory storage |
| 220, 420 | robot program |
| 222 | recording process |
| 224 | assisting process |
| 226 | robot task generator |
| 527 | parameter evaluation module |
| 528 | Robot task parameter module |
| 529 | Pattern and robot task storage |
| 330, 430 | Method of programming a robot system |
| 632 | selecting position of robot program |
| 637 | User interaction with robot system |
| 240 | controlling robot system |
| 250, 350, 650 | activating recording process |
| 252, 352, 652 | recording operational parameters |
| 353, 653 | storing operational parameter |
| 654 | recording and storing loop |
| 656 | de activates recording process |
| 260, 660 | activating assisting function |
| 262, 362, 662 | activating robot system action |
| 363, 633 | store operational parameter relating |
| | to assisting function |
| 668 | Notification of ended demonstration |
| 270 | generating robot task |
| 371 | obtaining at least one of the recorded operational |
| | parameters |
| 372 | obtaining at least one assisting parameter |
| 473 | evaluating obtained parameters |
| 474, 574a, 574b | setting parameters of robot task |
| 275, 475; 475′ | adding/inserting robot task into robot program |
| 677 | request input from user |
| 678 | request input from user |
| 779 | grid |
| 780 | start corner position of grid |
| 781 | end of first row |
| 782 | end corner position of grid |
| 783 | demonstrate the grid positions of the first row |
| 784 | demonstrate grid positions of last column |
| 688 | Sequence involving user |
| 690 | Sequence involving robot program |
| 692 | Sequence involving recording process |
| 694 | Sequence involving assisting function |
| 696 | Sequence involving task generator |
| T1-T5 | Robot tasks |

1. A robot system comprising at least one robotic arm controlled by a robot controller according to a robot program, where the robot program specifies a number of robot tasks and an order of execution of robot tasks, said robot system comprises a user interface device enabling a user to communicate with said robot system, wherein said robot controller is configured for performing:
a recording process which can be activated by a user via said user interface device and said robot controller is during said recording process configured to record at least one operation parameter of said robot system;
an assisting process which during said recording process is configured to execute at least one assisting function upon activation by said user, where said at least one assisting function activates at least one robot system action;
wherein the robot controller comprises:
a robot task generator configured to generate at least one robot task based on said at least one executed assisting function and at least one of said recorded operation parameters.

2. The robot system according to claim 1 wherein said user interface allows said user to define at least a part of said robot program by specifying at least one of said robot tasks and said order of execution of said robot tasks.

3. The robot system according to claim 1 wherein said assisting process is configured to execute robot program code causing said robot system to perform said robot system action.

4. The robot system according to claim 1 wherein said assisting function is configured to change at least one operational parameter of said robot system.

5. The robot system according to claim 1, wherein said assisting process is configured to instruct said recording process to record at least one operational parameter specified by said assisting function.

6. The robot system according to claim 1, wherein said robot task generator comprises a parameter evaluation module configured to identify at least one robot task based on said on at least one executed assisting function and at least one of said recorded operation parameters.

7. The robot system according to claim 1 wherein said assisting process is configured to generate at least one assisting parameter relating to said assisting function.

8. The robot system according to claim 6 wherein said parameter evaluation module is configured to identify at least one robot task based on said based said at least one assisting parameter and said at least one recorded operation parameters.

9. The robot system according to claim 1 wherein said assisting function is associated with at least one assisting setting parameter, where said assisting setting parameter indicates at least one parameter influencing the execution of said robot system action.

10. The robot system according to claim 6 wherein said a parameter evaluation module is configured to identify at least one robot task based on said based said at least one assisting setting parameter and said at least one recorded operation parameters.

11. The robot system according to claim 1 wherein said robot task generator comprises a robot task parameter setting module configured to set at least one parameter of said generated robot task.

12. The robot system according to claim 1 wherein said robot system action comprises at least one of the following actions:
movement of at least a part of said robotic arm;
activation of at least one end effector attached to said tool flange;
setting at least one output port of said robot system;
activating of at least one peripheral device forming part of said robot system.

13. The robot system according to claim 1 wherein said assisting function is configured to activate at least one additional assisting function, where said at least one additional assisting function activates at least one additional predefined robot system action.

14. The robot system according to claim 1 wherein said assisting function is configured to imitate at least a part of the robot system action without performing the robot system action.

15. The robot system according to claim 1, wherein said robot system action comprises movement of a part of said robotic arm until at least a part of said robotic arm come in contact with an object of said robotic system.

16. The robot system according to claim 15, wherein said operation parameter indicate the pose of said robotic arm upon contact between a part of said robotic arm and said object and where said robot task generator is configured to generate said at least one robot task based on said pose of said robotic arm.

17. A method of programming a robot system, said robot system comprising at least one robotic arm controlled by a robot controller according to a robot program, where said robot program specifies a number of robot tasks and an order of execution of said robot tasks, said method comprises the steps of:
· activating a recording process of said robot system, where said robot controller during said recording process records at least one operation parameter of said robot system;
during said recording process activating at least one assisting function of said robot system, where said at least one assisting functions activates at least one predefined robot system action;
generating at least one robot task to said robot program based on said selected at least one assisting function and at least one of said recorded operation parameters.

18. The method according to claim 17 wherein said method comprises a step of adding said robot task to said robot program.

19. The method according to claim 17 wherein said method during said recording process comprises one or ore steps of a user interacting with said robot system in order to change at least one operation parameter of said robot system.

20. The method according to claim 17 wherein said activation of said at least one predefined robot system action comprises a step of executing robot program code causing said robot system to perform said robot system action.

21. The method according to claim 17 wherein said method comprises a step of selecting a position of said robot program and where said step of adding at least one robot task is based on said selected position of said robot program.

22. The method according to claim 17 wherein said at least one assisting function causes at least one of said operation parameters of said robot system to change.

23. The method according to claim 17 wherein said at least one assisting function provides instructions to a user of said robot system.

24. The method according to claim 17 wherein execution of said assisting function moves at least at part of said robotic arm.

25. The method according to claim 17 wherein said operational parameter indicates at least one sensor parameter of said robot system.

26. The method according to claim 17 wherein said operational parameter indicates user interactions performed by the user with said robot system.

27. The method according to claim 17 wherein said step of adding at least one robot task to said robot program comprises a step of evaluating said recorded operation parameters based on said selected at least one assisting function.

28. The method according to claim 17 wherein said step of adding at least one task to said robot program comprises a step of generating robot program coded and adding said generated robot program coded to robot program coded to robot program code defining said robot program.

29. The method according to claim 17 wherein said assisting function is configured to activate at least one additional assisting function, where said sat at least one additional assisting function activates at least one additional predefined robot system action.

30. The method according to claim 17, wherein said robot system action comprises at step of moving a part of said robotic arm until at least a part of said robotic arm come in contact with an object of said robotic system.

31. The method robot system according to claim 30, wherein said operation parameter indicates the pose of said robotic arm upon contact between a part of said robotic arm and said object and wherein step of generating at least one robot task is based on said pose of said robotic arm.

32. A method of providing assisting functions to a robot system according to claim 1, wherein said method comprises the steps of:
defining at least one robot action to be performed by said robot system upon activation of said assisting function;
defining at least one robot tasks to be added to said robot program based on activation of said assisting function;
defining an evaluation scheme defining at least one property of said robot task based on said assisting function and at least one of said operational parameters.
